(19) United States
(12) Patent Application Publication
(10) Pub. No.: US 2025/0199468 A1
(43) Pub. Date: Jun. 19, 2025

(54) PROCESSING CARTRIDGE

(71) Applicant: Zhuhai Ninestar Information Technology Co. , Ltd, Zhuhai (CN)

(72) Inventors: Changbiao WANG, Zhuhai (CN); Hailong MA, Zhuhai (CN); Jiming ZHOU, Zhuhai (CN); Qingrui ZHU, Zhuhai (CN); Chaoxing LIU, Zhuhai (CN); Fengrong LI, Zhuhai (CN)

(21) Appl. No.: 19/066,121

(22) Filed: Feb. 27, 2025

Related U.S. Application Data
(63) Continuation of application No. PCT/CN2023/115620, filed on Aug. 29, 2023.

(30) Foreign Application Priority Data
Aug. 29, 2022 (CN) 202222286682.X
Sep. 30, 2022 (CN) 202222618773.9
Jul. 31, 2023 (CN) 202322043869.1

(51) Int. Cl. G03G 21/18

(52) U.S. Cl. CPC G03G 21/186; G03G 21/1864

(57) ABSTRACT

The present disclosure provides a processing cartridge and a coupling, where the process cartridge is detachably mounted in a main assembly of an electronic imaging device, the main assembly includes a drum drive transmission unit, the drum drive transmission unit includes a drum driving component and a braking force applying assembly, the drum driving component is provided with a driving force transmitting portion, and the coupling is capable of receiving a first force applied by the driving force transmitting portion to rotate. The coupling further includes an engagement part, which is a groove structure, where the groove structure of the engagement part is engaged with the driving force transmitting portion to receive the first force applied by the driving force transmitting portion to rotate.

### CROSS-REFERENCE TO RELATED APPLICATIONS

This application is a continuation of International Application No. PCT/CN2023/115620, filed on Aug. 29, 2023, which claims priority of Chinese Patent Application No. 202222286682.X filed on Aug. 29, 2022, Chinese Patent Application No. 202222618773.9 filed on Sep. 30, 2022, and Chinese Patent Application No. 202322043869.1 filed on Jul. 31, 2023, the entire content of each of which is hereby incorporated by reference.

### FIELD OF THE DISCLOSURE

The present disclosure relates to the technical field of electronic imaging device, and in particular to a processing cartridge.

### BACKGROUND

An image forming device of an electrophotographic method includes a processing cartridge for developing an electrostatic latent image on a photosensitive drum using a developer. The processing cartridge includes a developing unit and a drum unit. The developing unit includes a developing roller rotatably supported in a housing thereof, and the drum unit includes a photosensitive drum rotatably supported in a housing thereof. Development is performed by supplying toner stored in the housing from the developing roller to the photosensitive drum.

In the existing technologies, a photosensitive drum has a coupling, and when the processing cartridge is installed on an image forming device, the coupling engages with the drive transmission unit in the image forming device. However, when the processing cartridge needs to be removed from the image forming device, the coupling may not be able to be smoothly disengaged due to the specific structure of the coupling, resulting in the inability to complete the removal action.

### SUMMARY

The objective of the present disclosure is to provide a processing cartridge to solve the technical problems in the existing technologies, which may facilitate the smooth disengagement of the coupling and the drum driving component.

One aspect of the disclosure provides a coupling of a processing cartridge, where the process cartridge is detachably mounted in a main assembly of an electronic imaging device, the main assembly includes a drum drive transmission unit, the drum drive transmission unit includes a drum driving component and a braking force applying assembly, the drum driving component is provided with a driving force transmitting portion, and the coupling is capable of receiving a first force applied by the driving force transmitting portion to rotate. The coupling further includes an engagement part, which is a groove structure, where the groove structure of the engagement part is engaged with the driving force transmitting portion to receive the first force applied by the driving force transmitting portion to rotate.

In some embodiments, the drum driving component further includes a bevel part and a positioning part, and the driving force transmitting portion is connected to the bevel part and is located between the positioning part and the bevel part.

In some embodiments, an assembly groove is provided in the drum driving component, and the braking force applying assembly includes a first movable component; the driving force transmitting portion is formed in the assembly groove, and the first movable component is disposed in the assembly groove; and the positioning part is formed in the assembly groove and is disposed at a central axis position of the drum driving component, and the driving force transmitting portion is symmetrically arranged on opposite sides of a center line of the positioning part.

In some embodiments, the first movable component is movable in an axial direction relative to the drum driving component.

In some embodiments, the drum driving component is capable of moving in the axial direction and extending out by a preset distance.

In some embodiments, the drum driving component is capable of moving in the axial direction to achieve an extension or retraction action.

In some embodiments, the braking force applying assembly further includes a second movable component, the first movable component and the second movable component are engaged with each other, and the second movable component is located on an inner side of the first movable component, which means that the second movable component is closer to the positioning part of the drum driving component than the first movable component.

In some embodiments, the coupling further includes a positioning matching part, and when the processing cartridge is installed on the main assembly, the positioning part of the drum driving component is capable of being inserted into the positioning matching part for engagement.

In some embodiments, the positioning matching part is provided with a conical chamfer.

In some embodiments, the coupling further includes a separation part, the braking force applying assembly includes a movable component, and the movable component is capable of moving along an axial direction relative to the drum driving component; and when the processing cartridge is installed on the main assembly, the separation part is inserted into the movable component.

In some embodiments, the movable component includes a first movable component and a second movable component, the first movable component and the second movable component are engaged with each other; and the separation part is inserted between the first movable component and the second movable component.

In some embodiments, the separation part is an annular protrusion structure, and the engagement part is formed at a lower end of the separation part.

In some embodiments, a width of the groove structure of the engagement part is greater than or equal to a width of the driving force transmitting portion.

In some embodiments, the groove structure of the engagement part includes a first groove section and a second groove section, a width of the second groove section is greater than a width of the first groove section; and the width of the first groove section is adapted to the width of the driving force transmitting portion.

In some embodiments, there are two engaging parts, and the two engaging parts are symmetrically arranged on the coupling.

In some embodiments, a bottom wall is provided on the engagement part; and when the engagement part is engaged with the driving force transmitting portion, the bottom wall is engaged with at least a portion of the driving force transmitting portion to generate a force in an opposite direction to the first force applied by the driving force transmitting portion.

In some embodiments, when the bottom wall is engaged with the driving force transmitting portion, the bottom wall abuts against a surface of the driving force transmitting portion to generate the force in the opposite direction to the first force.

Another aspect of the disclosure provides a processing cartridge including a coupling, where the process cartridge is detachably mounted in a main assembly of an electronic imaging device, the main assembly includes a drum drive transmission unit, the drum drive transmission unit includes a drum driving component and a braking force applying assembly, the drum driving component is provided with a driving force transmitting portion, and the coupling is capable of receiving a first force applied by the driving force transmitting portion to rotate. The coupling further includes an engagement part, which is a groove structure, where the groove structure of the engagement part is engaged with the driving force transmitting portion to receive the first force applied by the driving force transmitting portion to rotate.

Other features of the present disclosure and advantages thereof will become apparent from the following detailed description of exemplary embodiments of the present disclosure with reference to the accompanying drawings.

### BRIEF DESCRIPTION OF THE DRAWINGS

The accompanying drawings, which are incorporated in and constitute a part of this specification, illustrate embodiments consistent with the present disclosure and, together with the descriptions, serve to explain the principles of the present disclosure.

FIG. 1 is a schematic structural diagram of a conventional image forming device.

FIG. 2 is an exploded perspective view of a drum driving component of a conventional image forming device.

FIG. 3 is a schematic structural diagram of a conventional first braking force engaging part and a braking transmission part.

FIG. 4 is a cross-sectional view of a conventional drum driving component.

FIG. 5 is a sectional perspective view of a conventional drum driving component.

FIG. 6 is an exploded perspective view of an existing drum driving component.

FIG. 7 is an overall schematic diagram of a processing cartridge from one angle of view.

FIG. 8 is an overall schematic diagram of a processing cartridge from another angle of view.

FIG. 9 is a schematic diagram of a photosensitive drum according to Embodiment 1.

FIG. 10 is a schematic diagram of a coupling according to Embodiment 1.

FIG. 11 is a schematic diagram of a process of inserting a coupling between movable components according to Embodiment 1.

FIG. 12 is a schematic diagram of an engagement process between a coupling and a drum driving component according to Embodiment 1.

FIG. 13 is a schematic diagram of a coupling inserted between movable components according to Embodiment 1.

FIG. 14 is a schematic diagram of an engagement between a coupling and a drum driving component according to Embodiment 1.

FIG. 15 is a schematic diagram of a coupling according to Embodiment 2.

FIG. 16 is an exploded perspective view of a coupling according to Embodiment 2.

FIG. 17 is a cross-sectional view of a coupling during an engagement process according to Embodiment 2.

FIG. 18 is a schematic diagram of an engagement process between a coupling and a drum driving component according to Embodiment 2.

FIG. 19 is a cross-sectional view of a coupling engagement according to Embodiment 2.

FIG. 20 is a schematic diagram of an engagement between a coupling and a drum driving component according to Embodiment 2.

FIG. 21 is a schematic diagram of a coupling according to Embodiment 3.

FIG. 22 is a disassembly diagram of a coupling according to Embodiment 3.

FIG. 23 is a cross-sectional view of an original state of a coupling according to Embodiment 3.

FIG. 24 is a schematic diagram of a process of inserting a coupling between the movable components according to Embodiment 3.

FIG. 25 is a cross-sectional view of a coupling during an engagement process according to Embodiment 3.

FIG. 26 is a schematic diagram of an engagement process between a coupling and a drum driving component according to Embodiment 3.

FIG. 27 is a schematic diagram of a coupling inserted between movable components according to Embodiment 3.

FIG. 28 is a schematic diagram of an engagement between a coupling and a drum driving component according to Embodiment 3.

FIG. 29 is a schematic diagram of a coupling according to Embodiment 4.

FIG. 30 is a schematic diagram of an engagement of a coupling with a drum driving component according to Embodiment 4.

FIG. 31 is a schematic diagram of a coupling according to Embodiment 5.

FIG. 32 is a schematic diagram of an engagement of a coupling and a drum driving component according to Embodiment 5.

FIG. 33 is a schematic structural diagram of a coupling from an angle of view according to Embodiment 6.

FIG. 34 is a schematic structural diagram of a coupling from another angle of view according to Embodiment 6.

FIG. 35 is a schematic structural diagram of the drum driving component according to Embodiment 7.

FIG. 36 is a schematic structural diagram of a coupling according to Embodiment 7.

FIG. 37 is a partial disassembly diagram of a conductive end of a processing cartridge according to Embodiment 8.

FIG. 38 is a cross-sectional view of a conductive end of the processing cartridge according to Embodiment 8.

FIG. 39 is a partial disassembly diagram of a conductive end of a processing cartridge according to Embodiment 9.

FIG. 40 is a cross-sectional view of a conductive end of a processing cartridge according to Embodiment 9.

FIG. 41 is a partial disassembly diagram of a conductive end of a processing cartridge according to Embodiment 10.

FIG. 42 is a cross-sectional view of a conductive end of a processing cartridge according to Embodiment 10.

FIG. 43 is a partial schematic structural diagram of a coupling and a photosensitive drum according to Embodiment 11.

FIG. 44 is a partial disassembly diagram of a coupling and a photosensitive drum according to Embodiment 11.

FIG. 45 is a schematic structural diagram of a photosensitive drum and a coupling according to Embodiment 12.

FIG. 46 is an exploded view of a coupling and a force-applying component according to Embodiment 12.

FIG. 47 is a partial cross-sectional view of a driving end of a processing cartridge according to Embodiment 12.

FIG. 48 is a partial cross-sectional view of a conductive end of a processing cartridge according to Embodiment 12.

### DESCRIPTION OF REFERENCE NUMERALS

100—processing cartridge, 101—conductive side end cover, 102—drive side end cover, 103—developing unit, 104—drum unit, 105—photosensitive drum, 106—coupling, 107—separating part, 108—engagement part, 109—positioning matching part, 110—first coupling body, 111—second coupling body, 112—through hole, 113—connecting shaft, 114—elastic part, 115—annular groove, 116—retaining ring, 117—guide column, 118—guide rib, 119—guide cavity, 120—guide groove, 121—first groove section, 122—second groove section, 123—pressing part, 124—driving force receiving block, 125—driving force receiving surface, 126—conductive bearing, 127—conductive shaft pin, 128—force-applying component, 129—annular groove, 130—developing frame, 131—drum frame, 132—developing coupling; M—image forming device, 170—main assembly, 171—tray, 180—drum driving component, 180a—bevel part, 180b—rotation stop portion, 180d—driving force transmitting portion, 180i—positioning part, 201—rotation part, 202—support shaft, 203—drum drive transmission unit, 204—first movable component, 204a—flange portion, 204e—protrusion, 204c—rotation stop recess, 206—braking component, 206a—fixed side, 206b—rotating side, 206d—end surface, 207—brake transmission member, 207a—flange portion, 207b—shaft portion, 207f—protrusion, 208—second movable component, 208c—rotation stop protrusion, 210—second engagement spring, 211—first engagement spring, 212—restriction component, 213—assembly groove, 214—first gap, 215—transfer slope; D1—first direction; A-preset rotation direction; and M1—first preset axis.

### DETAILED DESCRIPTION

The embodiments described below with reference to the accompanying drawings are exemplary and are merely used to explain the present disclosure, but should not be construed as limiting the present disclosure.

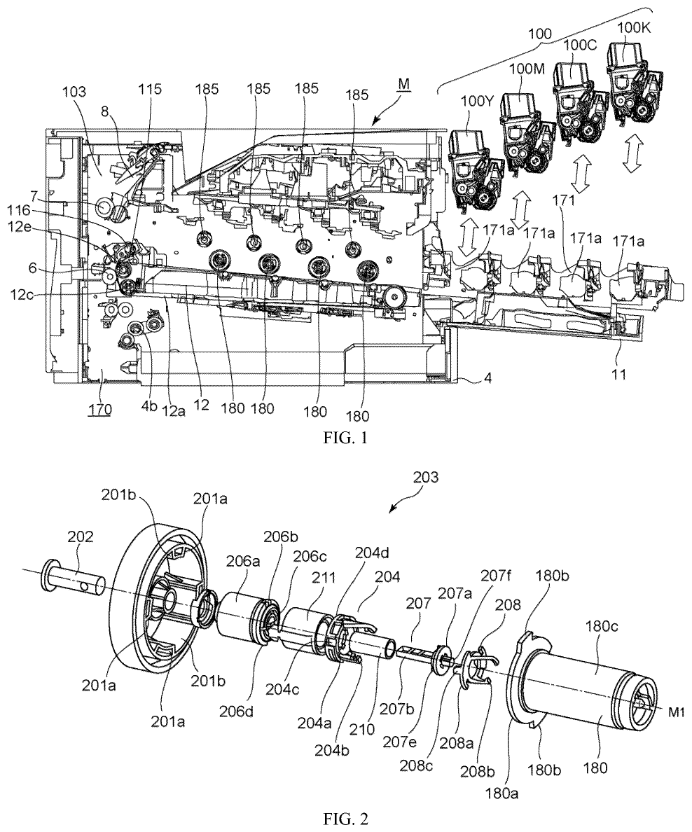

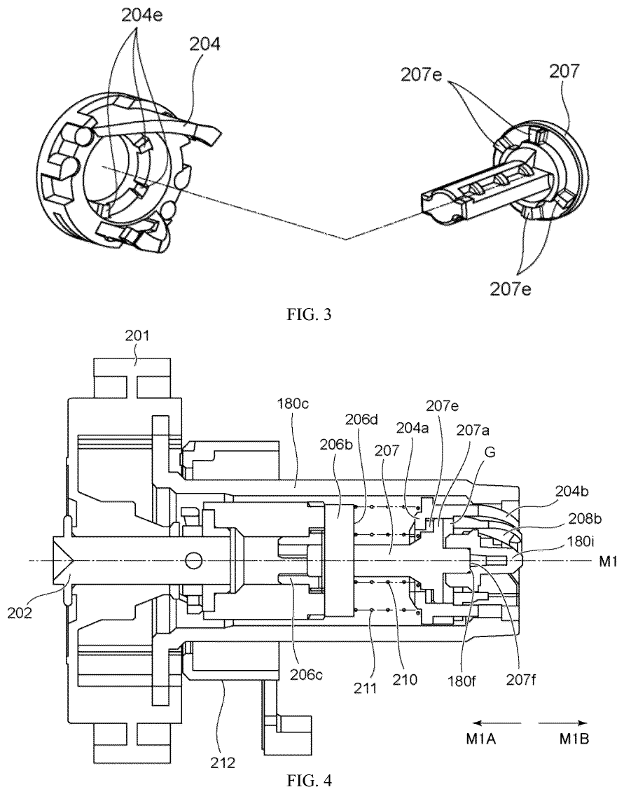

As shown in FIGS. 1 to 6, an electronic imaging device M includes a main assembly 170, a tray 171, and a door cover 11. The main assembly 170 is provided with a accommodating portion, a drum drive transmission unit 203, a separation mechanism, and a transfer printing unit, etc. The tray 171 may accommodate processing cartridges 100 and may move relative to the main assembly 170 to place the processing cartridges 100 into the accommodating portion of the main assembly 170. The door cover 11 is disposed on the outside of the main assembly 170, and may open or close the accommodating portion of the main assembly 170.

As shown in FIG. 1, four processing cartridges 100 (100Y, 100M, 100C, 100K) are arranged in the main assembly 170, namely the first processing cartridge 100Y, the second processing cartridge 100M, the third processing cartridge 100C and the fourth processing cartridge 100K. The four processing cartridges 100 are arranged substantially horizontally. The rotational driving force is respectively from a driving output part of the main assembly 170, and the main assembly 170 provides bias voltages (e.g., charging bias, developing bias, etc.) to the first to fourth processing cartridges 100 (100Y, 100M, 100C, 100K). The processing cartridges 100 are placed into the main assembly 170 through a tray 171. Specifically, the tray 171 is configured to be able to move in a substantially horizontal direction when the main assembly 170 is placed on a horizontal surface, and the four processing cartridges 100 are respectively placed into each positioning part of the tray 171. When the tray 171 is moved into the main assembly 170, the processing cartridges 100 are moved together with the tray 171 into the main assembly 170. When the processing cartridges 100 need to be replaced, the processing cartridges 100 may be moved together with the tray 171 to the outside of the main assembly 170.

A processing cartridge 100 has a developing coupling (e.g., developing driving force receiving part) and a drum coupling (e.g., photosensitive unit coupling). When the door cover 11 of the main assembly 170 is closed, a driving force is transmitted to a drum drive transmission unit 203 on the main assembly side of the processing cartridge to engage with the developing drive transmission unit, to transmit the driving force to the processing cartridge.

When the door cover 11 is opened, the drum drive transmission unit 203 and the developing drive transmission unit are retracted and detached from the drum coupling and the developing coupling of the processing cartridge 100, so that the tray 171 and the processing cartridge 100 may be smoothly removed from the main assembly 170.

As shown in FIGS. 2 and 4, the drum drive transmission unit 203 arranged on the main assembly 170 includes a driving force transmission unit and a braking force applying assembly, where the driving force transmission unit includes a rotation part 201 and a drum driving component 180. The rotation part 201 is rotatably supported on the support shaft 202, and one end of the drum driving component 180 is provided with a rotation stop portion 180b for receiving the driving force, and the other end is provided with a driving force transmitting portion 180d. The drum driving component 180 has a basic structure of a hollow cylindrical shape, and a pair of spaced and oppositely arranged bevel parts 180a are formed in the inner cavity thereof, protruding from the inner wall toward the rotation center close to the drum driving component 180. A connecting frame 180d (also called a driving force transmitting portion) constructed as a block structure is connected between the pair of bevel parts 180a, and a positioning part 180i is provided at the middle position of the connecting frame 180d. The positioning part 180i is configured to extend outward from the approximate center position of the connecting frame 180d, that is, the positioning part 180i is formed at the central axis position of the drum driving component 180. In the drum driving component 180, there are two block structures of the driving force transmitting portion 180d, and the two block structures are symmetrically arranged on opposite sides of the center line of the positioning part 180i.

The drum driving component 180 is assembled on the rotation part 201 in a manner that it may move along the axial direction M1. The rotation part 201 drives the drum driving component 180 to rotate through the cooperation between the rotation stop portion 201b of the rotation part 201 and the rotation stop portion 180b of the drum driving component 180.

As shown in FIGS. 2 to 6, the braking force applying assembly includes a braking component 206, a first movable component 204, a second movable component 208, a first engagement spring 211, a second engagement spring 210 and a brake transmission member 207, where the braking component 206 includes a fixed side 206a and a rotating side 206b, the fixed side 206a is fixedly connected to the support shaft 202, and the rotating side 206b is capable of rotating relative to the fixed side 206a and generating a braking force. The method for generating the braking force may be appropriately selected from those methods using friction and viscosity.

The first movable component 204 and the second movable component 208 are configured to apply a braking force to the processing cartridge 100. The two may be assembled together by engaging the rotation stop protrusion 208c and the rotation stop recess 204c, and the two may have a synchronous action process. The second movable component 208 is located inside the first movable component 204, and the engagement part 204b of the first movable component 204 and the bevel part 180a may attach or abut against each other.

The shaft portion 207b of the brake transmission member 207 passes through the through holes in the middle of the first and second movable components 204 and 208 and is connected to the rotating side 206b of the braking component 206 to allow to transmit the braking force to the first and second movable components 204 and 208.

Specifically, the flange portion 207a of the brake transmission member 207 is provided with a protrusion 207e, and the flange portion 204a of the first movable component 204 is correspondingly provided with a protrusion 204e. When the protrusion 207e of the brake transmission member 207 engages with the protrusion 204e of the first movable component 204, the brake transmission member 207 may transmit the braking force to the first movable component 204.

The first movable component 204 and the second movable component 208 may move along the first preset axis M1 relative to the brake transmission member 207 and the braking component 206. When the protrusion 207e of the brake transmission member 207 is offset or separated from the protrusion 204e of the first movable component 204 along the first preset axis M1, the second movable component 208 and the first movable component 204 will not receive the braking force.

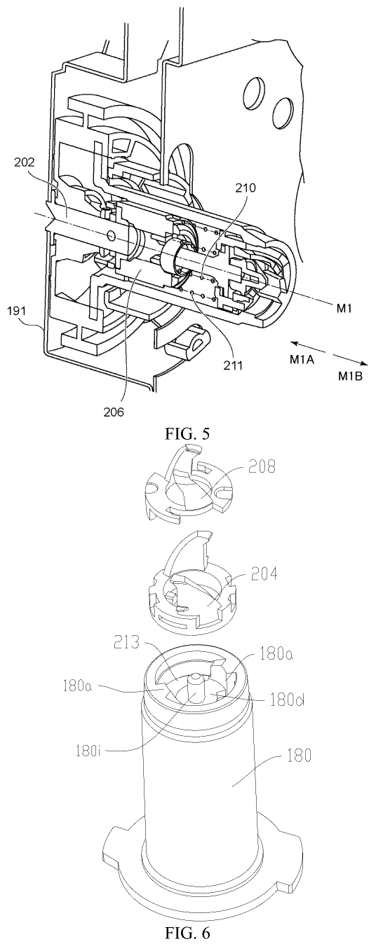

Continue to refer to FIGS. 4 and 5, one end of the first engagement spring 211 presses against the end face 206d of the braking component 206, and the other end presses against the flange portion 204a of the first movable component 204. The first engagement spring 211 is in a compressed state, and applies an elastic force to the first movable component 204 along the M1B direction. The elastic force may keep the protrusion 207e of the brake transmission member 207 engaged with the protrusion 204e of the first movable component 204.

The second engagement spring 210 is a compression coil spring and is configured to be clamped and compressed between the end face 206d of the braking component 206 and the flange portion 207a of the brake transmission member 207. The second engagement spring 210 applies a repulsive force (pushing force, elastic force) to each of the end face 206d of the braking component 206 and the flange portion 207a of the brake transmission member 207.

Among the components of the drum drive transmission unit 203 described above, under the action of the first engagement spring 211 and the second engagement spring 210, the protrusion 207f at the end of the brake transmission member 207 in the axial direction M1A abuts against the contact surface 108f of the drum driving component 180. The movement of the drum driving component 180 in the arrow M1B direction is regulated (restricted) by the axial direction restriction component 212 so that the drum driving component 180 does not fall off the drum drive transmission unit 203 on the main assembly 170 side.

Among the various components of the aforementioned drum drive transmission unit 203, the drum driving component 180 is capable of moving in the M1A and M1B directions relative to the rotation part 201. The first movable component 204 and the second movable component 208 are capable of moving in the M1A and M1B directions relative to the brake transmission member 207 and the rotation part 201, and are also capable of moving in the M1A and M1B directions relative to the drum driving component 180.

As shown in FIGS. 2 to 6, in the existing technologies, when the drum driving component 180 rotates and the processing cartridge is not matched with the drum driving component 180, that is, when the drum driving component 180 is idling, the raised portion of the drum driving component 180 on the M1A side squeezes the raised portion of the brake transmission member 207 on the M1B side, and both raised portions are inclined surfaces, so that the brake transmission member 207 moves toward the inside of the drum driving component 180 (moves along the M1A direction), and the brake transmission member 207 drives the first movable component 204 and the second movable component 208 to also move toward the inside of the drum driving component 180. When the drum driving component 180 rotates until its raised portion passes the raised portion of the brake transmission member 207, the brake transmission member 207, the first movable component 204 and the second movable component 208 rebound (move in the direction of M1B) and produce an abnormal sound under the action of the first engagement spring 211 and the second engagement spring 210. When the drum driving component 180 rotates to the bevel parts 180a and contacts with the first movable component 204, the drum driving component 180 drives the first movable component 204 to rotate, while the brake transmission member 207 does not rotate. When the first movable component 204 rotates to a position where the protrusion 204e of the first movable component 204 contacts the protrusion 207e of the brake transmission member 207, the first movable component 204 moves toward the inside of the drum driving component 180. After the protrusion 204e of the first movable component 204 passes through the protrusion 207e of the brake transmission member 207, the first movable component 204 rebounds and produces an abnormal sound.

An assembly groove 213 is provided in the drum driving component 180. The assembly groove 213 forms an opening on the surface of the drum driving component 180. The opening is arranged facing the position of the coupling 106. The extension direction of the assembly groove 213 is parallel to the first direction D1. When the processing cartridges 100 are placed in the image forming device, the drum driving component 180 moves along the first direction D1 toward the coupling 106. The coupling 106 may extend from the opening into the assembly groove 213. The driving force transmitting portion 180d is formed in the assembly groove 213.

### Embodiment 1

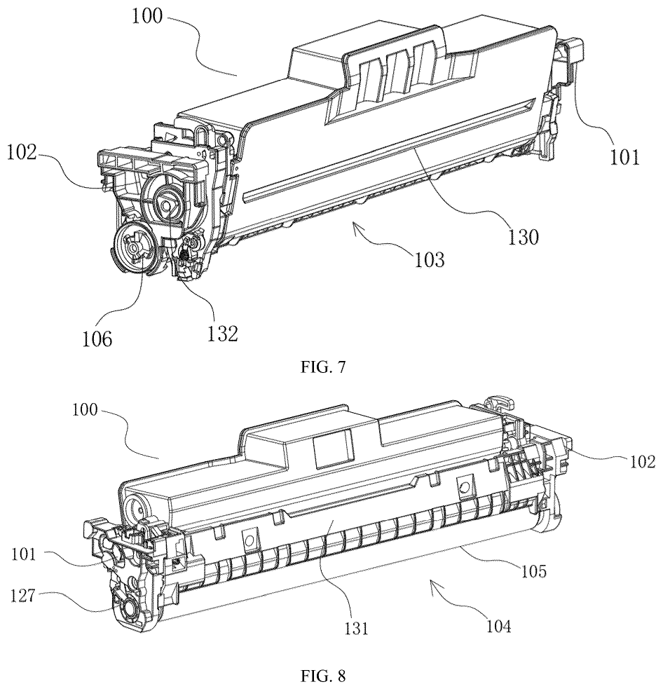

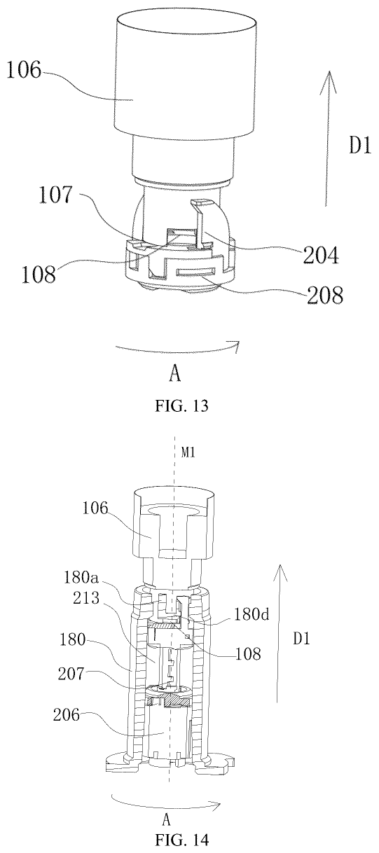

Referring to FIGS. 7 to 14, the present disclosure provides a processing cartridge 100 for installation in an image forming device.

The processing cartridge 100 includes a developing unit 103, a drum unit 104 and a driving assembly.

The developing unit 103 includes a developing frame 130, a developing roller, a developing coupling 132, a developing roller gear, a powder feeding roller, a powder feeding roller gear and a powder discharge knife. The drum unit 104 includes a drum frame 131, a photosensitive drum 105, a coupling 106 and a charging roller.

The developing frame 130 forms a powder bin for storing toner, and the developing frame 130 is roughly in the shape of a long box. The developing frame 130 is provided with a driving side bearing and a conductive side bearing at both ends of the length direction, respectively. The powder feeding roller and the developing roller are rotatably supported on the driving side bearing and the conductive side bearing at both ends of the length direction of the developing frame 130. The powder feeding roller and the developing roller may rotate under the action of the driving assembly, and the axial directions of the powder feeding roller and the developing roller are along the length direction of the developing frame 130. The powder feeding roller transports the toner to the developing roller, which is adsorbed by the charged developing roller.

The drum frame 131 also has a length direction, which is consistent with the length direction of the developing frame 130. The two ends of the drum frame 131 in the length direction are respectively provided with a drive side end cover 102 and a conductive side end cover 101. The photosensitive drum 105 is rotatably supported on the two ends of the drum frame 131 in the length direction, specifically supported on the drive side end cover 102 and the conductive side end cover 101. The two ends of the photosensitive drum 105 in the axial direction are respectively provided with a driving bearing and a conductive bearing. The photosensitive drum 105 is supported on the through holes of the drive side end cover 102 and the conductive side end cover 101 respectively through the driving bearing and the conductive bearing. The photosensitive drum 105 is arranged on the lower side of the drum frame 131 in the height direction. The developing unit 103 and the drum unit 104 are connected to each other through the drive side end cover 102 and the conductive side end cover 101. The developing roller and the photosensitive drum 105 are close to each other. The toner adsorbed by the developing roller is transferred to the photosensitive drum 105 through the potential difference between the developing roller and the photosensitive drum 105. The charging roller is used to charge the surface of the photosensitive drum 105 with a uniform charge so that the photosensitive drum 105 may adsorb the toner.

The developing coupling 132, the developing roller gear, the powder feeding roller gear and the stirring frame gear are arranged on the outer side of the driving side bearing. Specifically, the driving side bearing is provided with a supporting hole for supporting the developing coupling 132, and the developing coupling 132 is used to engage with the developing drive transmission unit of the electronic imaging device and receive the driving force. The developing roller gear is sleeved on the end of the developing roller shaft extending from the driving side bearing, and the powder feeding roller gear is sleeved on the end of the powder feeding roller shaft extending from the driving side bearing. The developing roller gear and the powder feeding roller gear are directly or indirectly engaged with the developing coupling 132 to transmit the driving force received by the developing coupling 132, thereby driving the developing roller and the powder feeding roller to rotate.

The coupling 106 is disposed at the end of the photosensitive drum 105 in the length direction (axial direction), and the coupling 106 is configured to receive the driving force of the electronic imaging device (transmitted by engaging with the drum driving component 180) to drive the photosensitive drum 105 to rotate.

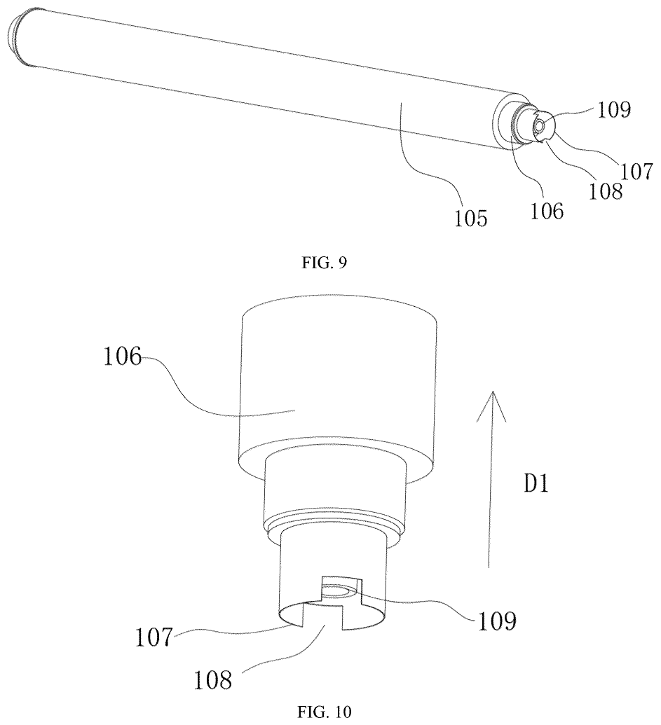

As shown in FIG. 9, the first end of the coupling 106 in the disclosed embodiment is connected to the shaft end of the photosensitive drum 105. The first end of the coupling 106 is provided with a recess (not shown in the figure) that may play a role of engagement with the photosensitive drum 105 or the two may serve as installation orientation identification points during installation. The second end of the coupling 106 is provided with a separation part 107 and an engagement part 108, where the separation part 107 and the engagement part 108 are sequentially distributed along the preset rotation direction A.

The separation part 107 includes an annular protrusion structure protruding from the second end of the coupling 106, and the engagement part 108 is a groove structure recessed on the end surface of the annular protrusion structure. The position and size of the engagement part 108 correspond to the position and size of the driving force transmitting portion 180d.

In the disclosed embodiment, referring to FIGS. 4 and 10, a positioning part 180i is provided in the assembly groove 213, and a positioning matching part 109 is provided on the coupling 106. The positioning matching part 109 is used to form a positioning match with the positioning part 180i. In some embodiments, the positioning part 180i is a positioning boss protruding from the driving force transmitting portion 180d, and the axis of the positioning boss coincides with the axis of the driving force transmitting portion 180d. The positioning boss extends toward the open direction of the assembly groove 213. The positioning matching part 109 is a positioning convex ring protruding from the second end of the coupling 106. The inner ring surface of the positioning convex ring is clearance-matched with the outer peripheral surface of the positioning boss. Optionally, the inner ring surface of the positioning convex ring may be provided with a conical chamfer, so that it plays a guiding role in the process of engagement between the positioning boss and the positioning convex ring.

The thickness of the separation part 107 is unevenly arranged along the first direction D1, which is conducive to generating friction or interference force between the separation part 107 and the movable components, so that the drum unit 104 and the image forming device are more firmly installed and the engagement is more stable during printing.

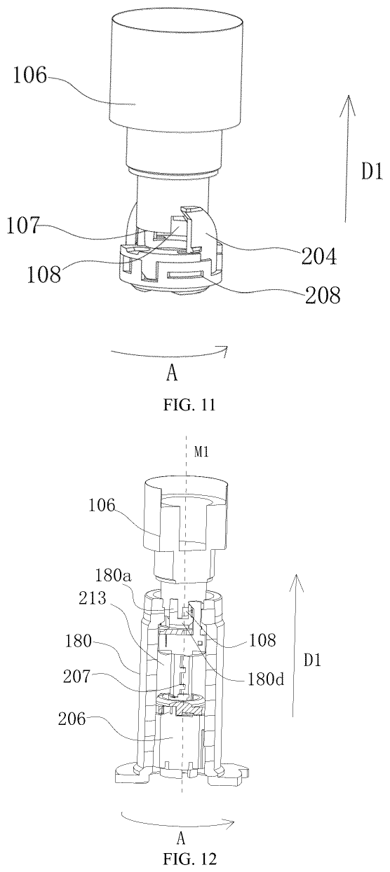

The engagement process between the coupling 106 and the drum driving component 180 is described in detail with reference to FIGS. 11-14. There are two initial postures (initial relative positions) between the coupling 106 and the drum driving component 180, which are divided into a first posture and a second posture. The first posture refers to the engagement part 108 provided on the coupling 106 being located on the upstream side of the corresponding position of the driving force transmitting portion 180d provided on the driving force transmitting portion 180d along the rotation direction A. The drum driving component 180 needs to rotate a certain distance along the A direction to reach the second posture (i.e., the engagement part 108 is located directly above the corresponding driving force transmitting portion 180d, and the engagement part 108 and the driving force transmitting portion 180d may be directly engaged).

The working process of the embodiment disclosed herein is:

When the drum driving component 180 is in the first posture, when the processing cartridge 100 needs to be placed in the image forming device, the processing cartridge 100 is placed on the tray, and then the processing cartridge 100 and the tray are pushed into the image forming device, the front door is closed, and the drum driving component 180 extends along the first direction D1 to engage with the coupling 106 on the drum unit 104. When the drum driving component 180 extends along the first direction D1, the separation part 107 provided on the coupling 106 is inserted between the movable components (the first movable component 204 and the second movable component 208). Since the engagement part 108 provided on the coupling 106 is located at the upstream side of the corresponding position of the driving force transmitting portion 180d provided on the drum driving component 180 along the preset rotation direction A, that is, the engagement part 108 and the driving force transmitting portion 180d are not correspondingly engaged. At this moment, the lower end surface of the separation part 107 abuts against the upper end surface of the driving force transmitting portion 180d, and at this point, the drum driving component 180 and the coupling 106 may move relative to each other.

Next, the drum driving component 180 starts to rotate along the preset rotation direction A under the drive of the motor. Since the engagement part 108 provided on the coupling 106 is located at the upstream side of the corresponding position of the driving force transmitting portion 180d provided on the drum driving component 180 along the preset rotation direction A, and the drum driving component 180 and the coupling 106 may move relative to each other. After the drum driving component 180 rotates a certain distance along the preset rotation direction A, the drum driving component 180 reaches the second posture, that is, the engagement part 108 is located at the position corresponding to the driving force transmitting portion 180d. At this moment, the drum driving component 180 moves along the first direction D1 and extends out by a preset distance, and the engagement part 108 is engaged with the driving force transmitting portion 180d, so that the coupling 106 may receive the first force applied by the drum driving component 180 and rotate synchronously with the drum driving component 180 along the preset rotation direction A. The coupling 106 drives the movable components to rotate, and then the drum unit 104 rotates, thereby completing the driving action.

When the drum driving component 180 is in the second posture, when the processing cartridge 100 needs to be placed in the image forming device, the processing cartridge 100 is placed on the tray, and then the processing cartridge 100 and the tray are pushed into the image forming device, the front door is closed, and the drum driving component 180 extends along the first direction D1 to engage with the coupling 106 on the drum unit 104. When the drum driving component 180 extends along the first direction D1, the separation part 107 provided on the coupling 106 is inserted between the movable components (the first movable component 204 and the second movable component 208), and the engagement part 108 corresponds to the position of the driving force transmitting portion 180d, so the coupling 106 may be directly engaged with the drum driving component 180, and then the drum driving component 180 starts to rotate along the preset rotation direction A. The engagement part 108 is engaged with the driving force transmitting portion 180d, so that the coupling 106 may receive the first force applied by the drum driving component 180 and rotate synchronously with the drum driving component 180 along the preset rotation direction A. The coupling 106 drives the movable components to rotate, and then the drum unit 104 rotates, thereby completing the driving action.

When the processing cartridge 100 needs to be disassembled from the image forming device, the drum driving component 180 stops rotating and retreats in the opposite direction to the first direction D1. Since the separation part 107 and the engagement part 108 of the coupling 106 will not interfere with the movement of the drum driving component 180, it may not only ensure the normal and stable printing process, but also facilitate the separation of the coupling 106 and the drum driving component 180, prevent the coupling 106 and the drum driving component 180 from being unable to separate smoothly, and ensure that a user can successfully complete the disassembly action.

The use of this structure facilitates the disengagement of the coupling 106 and the drum driving component 180. There are no snap points or reverse snap points, which prevents the coupling 106 and the drum driving component 180 from being unable to disengage smoothly, ensuring that the user may successfully complete the disassembly action.

### Embodiment 2

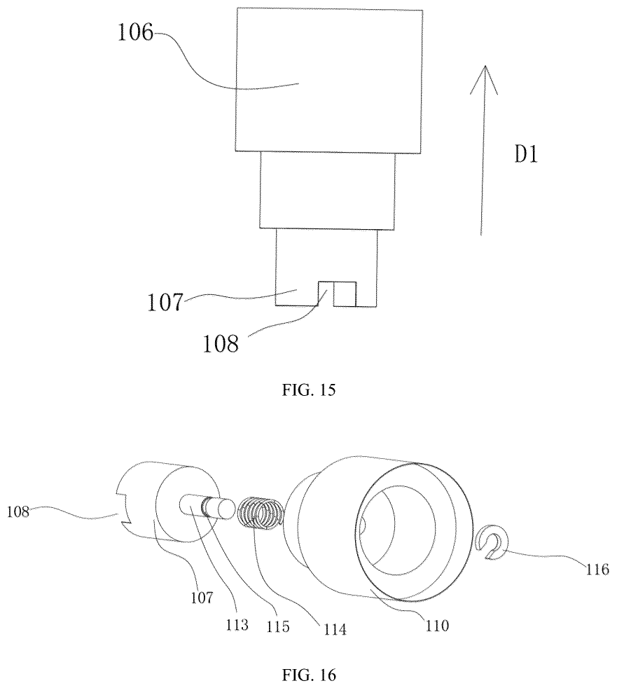

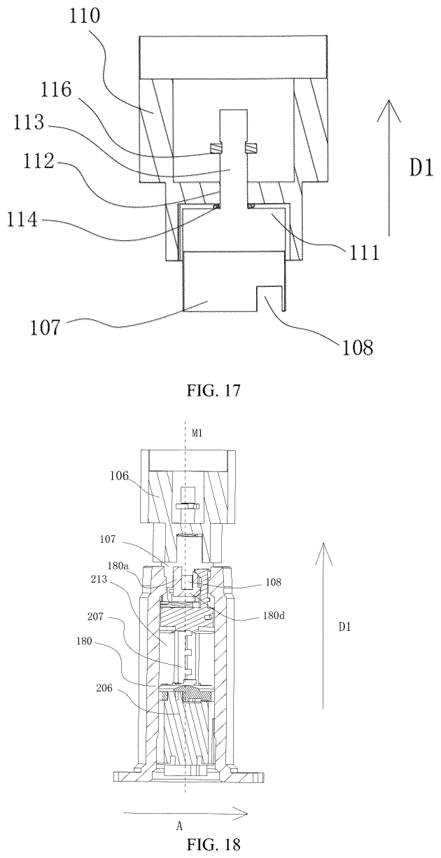

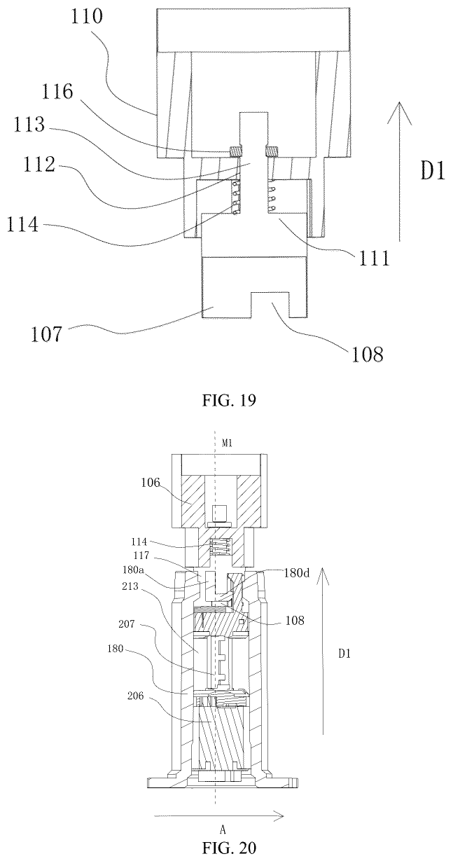

Referring to FIGS. 15 to 20, in the disclosed embodiment, different from Embodiment 1, the coupling 106 includes a first coupling body 110 and a second coupling body 111, the first end of the first coupling body 110 is connected to the photosensitive drum 105, and an elastic part 114 is arranged between the first coupling body 110 and the second coupling body 111, so that the first end of the second coupling body 111 is elastically connected to the second end of the first coupling body 110, so that the second coupling body 111 may elastically reciprocate along the first direction D1. The separation part 107 and the engagement part 108 are both formed at the second end of the second coupling body 111.

In some embodiments, a through hole 112 is provided on the first coupling body 110, and a connecting shaft 113 protrudes from the side of the second coupling body 111 facing the first coupling body 110, and the connecting shaft 113 is loosely fitted in the through hole 112. The elastic part 114 is preferably a tension spring, and the elastic part 114 is looped on the connecting shaft 113. The opposite ends of the elastic part 114 are respectively in contact with the first coupling body 110 and the second coupling body 111. During the movement of the second coupling body 111 toward the first coupling body 110, the elastic part 114 is squeezed, and the elastic part 114 accumulates elastic restoring force, so that the second coupling body 111 may return to its initial position.

An annular groove 115 is recessed on the outer circumferential surface of one end of the connecting shaft 113 protruding from the through hole 112, and a retaining ring 116 is embedded in the annular groove 115. The diameter of the retaining ring 116 is larger than the inner diameter of the through hole 112. The retaining ring 116 serves as a limit to prevent the second coupling body 111 from shifting and falling off during movement.

The working process of the embodiment disclosed herein is:

When the drum driving component 180 is in the first posture, when the processing cartridge 100 needs to be placed in the image forming device, the processing cartridge 100 is placed on the tray, and then the processing cartridge 100 and the tray are pushed into the image forming device, the front door is closed, and the drum driving component 180 extends along the first direction D1 to engage with the drum unit 104. When the drum driving component 180 extends along the first direction D1, the separation part 107 provided on the coupling 106 is inserted between the movable components (the first movable component 204 and the second movable component 208). Since the engagement part 108 provided on the coupling 106 is located on the upstream side of the corresponding position of the driving force transmitting portion 180d provided on the drum driving component 180 along the preset rotation direction A, that is, the engagement part 108 and the driving force transmitting portion 180d are not correspondingly engaged, the lower end surface of the separation part 107 abuts against the upper end surface of the driving force transmitting portion 180d. At this moment, the elastic part 114 is compressed and the elastic restoring force is accumulated. At this moment, the drum driving component 180 and the coupling 106 may move relative to each other.

Next, the drum driving component 180 starts to rotate along the preset rotation direction A under the drive of the motor. Since the engagement part 108 provided on the coupling 106 is located at the upstream side of the corresponding position of the driving force transmitting portion 180d provided on the drum driving component 180 along the preset rotation direction A, and the drum driving component 180 and the coupling 106 may move relative to each other, after the drum driving component 180 rotates a certain distance along the preset rotation direction A, the drum driving component 180 reaches the second posture, that is, the engagement part 108 is located at the position corresponding to the driving force transmitting portion 180d. The first coupling body 110 no longer abuts against the drum driving component 180. At this moment, the elastic restoring force of the elastic part 114 is released, so that the second coupling body 111 moves toward one side of the drum driving component 180, and the engagement part 108 is engaged with the driving force transmitting portion 180d, so that the coupling 106 may receive the first force applied by the drum driving component 180 and rotate synchronously with the drum driving component 180 along the preset rotation direction A. The coupling 106 drives the movable components to rotate, and then the drum unit 104 rotates, thereby completing the driving action.

When the drum driving component 180 is in the second posture, when the processing cartridge 100 needs to be placed in the image forming device, the processing cartridge 100 is placed on the tray, and then the processing cartridge 100 and the tray are pushed into the image forming device, the front door is closed, and the drum driving component 180 extends along the first direction D1 to engage with the drum unit 104. When the drum driving component 180 extends along the first direction D1, the separation part 107 provided on the coupling 106 is inserted between the movable components (the first movable component 204 and the second movable component 208), and the engagement part 108 corresponds to the position of the driving force transmitting portion 180d, so the coupling 106 may be directly engaged with the drum driving component 180, and then the drum driving component 180 starts to rotate along the preset rotation direction A. The engagement part 108 is engaged with the driving force transmitting portion 180d, so that the coupling 106 may receive the first force applied by the drum driving component 180 and rotate synchronously with the drum driving component 180 along the preset rotation direction A. The coupling 106 drives the movable components to rotate, and then the drum unit 104 rotates, thereby completing the driving action.

The other structures of the processing cartridge 100 of Embodiment 2 are similar to those of Embodiment 1 and will not be described again.

### Embodiment 3

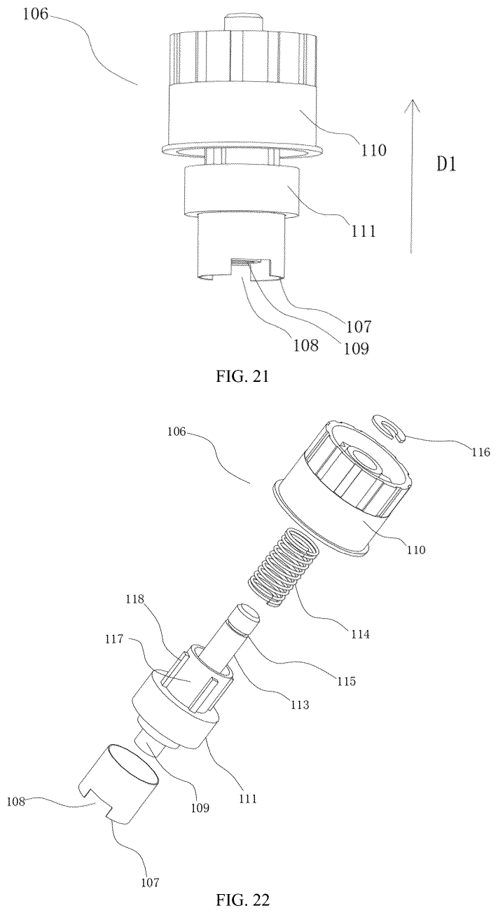

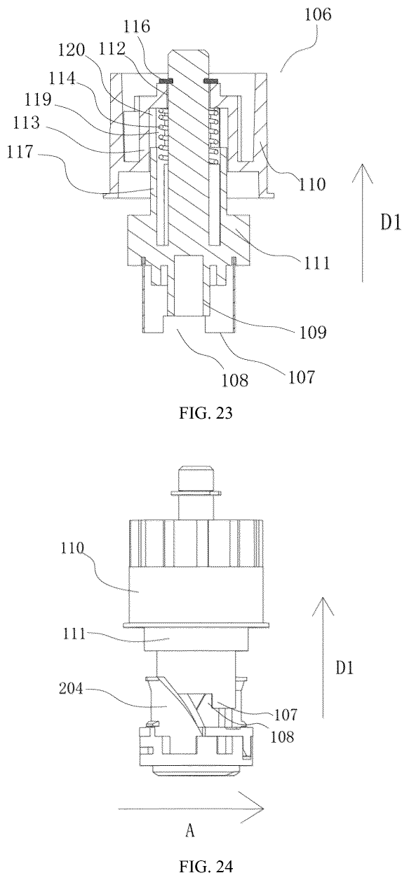

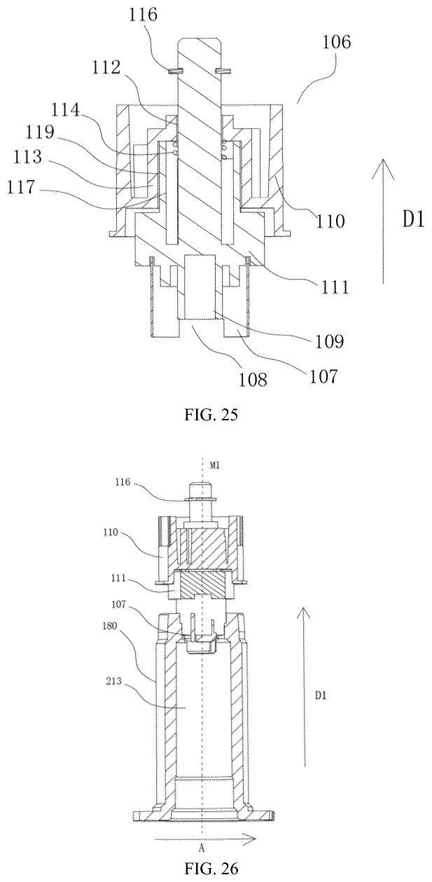

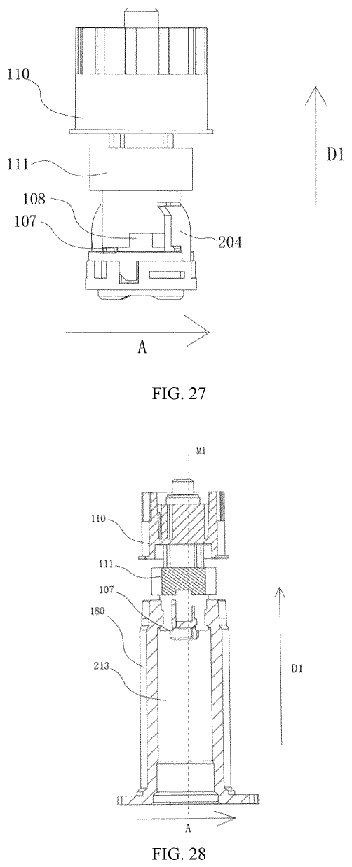

Referring to FIGS. 21 to 28, in the disclosed embodiment, different from Embodiment 1, the coupling 106 includes a first coupling body 110 and a second coupling body 111, and the first end of the first coupling body 110 is connected to the photosensitive drum 105. An elastic part 114 is arranged between the first coupling body 110 and the second coupling body 111, so that the first end of the second coupling body 111 is elastically connected to the second end of the first coupling body 110, so that the second coupling body 111 may elastically reciprocate along the first direction D1. The separation part 107 and the engagement part 108 are both formed at the second end of the second coupling body 111.

In some embodiments, a through hole 112 is provided on the first coupling body 110, and a connecting shaft 113 protrudes from the side of the second coupling body 111 facing the first coupling body 110, and the connecting shaft 113 is loosely fitted in the through hole 112. The elastic part 114 is preferably a tension spring, and the elastic part 114 is looped on the connecting shaft 113. The opposite ends of the elastic part 114 are respectively in contact with the first coupling body 110 and the second coupling body 111. During the movement of the second coupling body 111 toward the first coupling body 110, the elastic part 114 is squeezed, and the elastic part 114 accumulates elastic restoring force, so that the second coupling body 111 may return to its initial position.

An annular groove 115 is recessed on the outer circumferential surface of one end of the connecting shaft 113 protruding from the through hole 112, and a retaining ring 116 is embedded in the annular groove 115. The diameter of the retaining ring 116 is larger than the inner diameter of the through hole 112. The retaining ring 116 serves as a limit to prevent the second coupling body 111 from shifting and falling off during movement.

The first coupling body 110 and the second coupling body 111 may move relative to each other along the first direction D1, but the relative rotational movement between the first coupling body 110 and the second coupling body 111 is limited, and the first coupling body 110 and the second coupling body 111 keep synchronous rotation. In some embodiments, a guide column 117 is convexly provided on the second coupling body 111, and a guide rib 118 is provided on the outer peripheral surface of the guide column 117. A guide cavity 119 is recessed on one side of the first coupling body 110 facing the second coupling body 111. The through hole 112 is arranged on the bottom wall of the guide cavity 119, and a guide groove 120 is recessed on the side wall of the guide cavity 119. The guide groove 120 and the guide rib 118 both extend along the first direction D1. The positions of the guide groove 120 and the guide rib 118 correspond to each other. The guide column 117 extends into the guide cavity 119, and the guide rib 118 and the guide groove 120 form a clearance fit, thereby limiting the relative rotation between the second coupling body 111 and the first coupling body 110. The second coupling body 111 may only move back and forth along the first direction D1.

In the disclosed embodiment, the separation part 107 is an annular protrusion structure, the outer diameter of the ring is approximately 10.9 mm, the inner diameter is 10.5 mm, and the thickness is approximately 0.2 mm. This is conducive to the separation part 107 being inserted between the movable components. The thickness of the annular column may be evenly set along the first direction D1, or unevenly set along the first direction D1. The thickness of the annular column is unevenly set along the first direction D1, which is conducive to the separation part 107 and the movable component to generate friction or interference force, so that the processing cartridge 100 and the image forming device are installed more firmly and the connection is more stable during the printing process.

The length of the separation part 107 along the first direction D1 is greater than or equal to the distance between the upper surface of the driving force transmitting portion 180d and the upper surface of the drum driving component 180, so as to ensure that the driving force transmitting portion 180d is engaged with the engagement part 108 and is used to receive the first force applied by the driving force transmitting portion 180d. Specifically, the length of the separation part 107 along the first direction D1 is approximately 5 mm.

The width of the engagement part 108 along the preset rotation direction A is greater than or equal to the width of the driving force transmitting portion 180d along the preset rotation direction A, which is conducive to the engagement part 108 adapting to the width of the driving force transmitting portion 180d and engaging with the driving force transmitting portion 180d. Specifically, the circumferential length of the engagement part 108 along the preset rotation direction A is greater than or equal to 3.8 mm.

The depth of the engagement part 108 along the first direction D1 is greater than or equal to the thickness of the driving force transmitting portion 180d along the first direction D1, which is conducive to the engagement part 108 and the driving force transmitting portion 180d being stably engaged and receiving the driving force applied by the driving force transmitting portion 180d. Specifically, the depth of the engagement part 108 along the first direction D1 is approximately 0.5 mm, so as to ensure that the engagement part 108 and the driving force transmitting portion 180d are stably engaged and may stably receive the driving force applied by the driving force transmitting portion 180d.

The working process of the embodiment disclosed herein is:

When the drum driving component 180 is in the first posture, when the processing cartridge 100 needs to be placed in the image forming device, the processing cartridge 100 is placed on the tray, and then the processing cartridge 100 and the tray are pushed into the image forming device, the front door is closed, and the drum driving component 180 extends along the first direction D1 to engage with the drum unit 104. When the drum driving component 180 extends along the first direction D1, the separation part 107 provided on the coupling 106 is inserted between the movable components (the first movable component 204 and the second movable component 208). Since the engagement part 108 provided on the coupling 106 is located on the upstream side of the corresponding position of the driving force transmitting portion 180d provided on the drum driving component 180 along the preset rotation direction A, that is, the engagement part 108 and the driving force transmitting portion 180d are not correspondingly engaged, the lower end surface of the separation part 107 abuts against the upper end surface of the driving force transmitting portion 180d. At this moment, the elastic part 114 is compressed and the elastic restoring force is accumulated. At this moment, the drum driving component 180 and the coupling 106 may move relative to each other.

Next, the drum driving component 180 starts to rotate along the preset rotation direction A under the drive of the motor. Since the engagement part 108 provided on the coupling 106 is located at the upstream side of the corresponding position of the driving force transmitting portion 180d provided on the drum driving component 180 along the preset rotation direction A, and the drum driving component 180 and the coupling 106 may move relative to each other, after the drum driving component 180 rotates a certain distance along the preset rotation direction A, the drum driving component 180 reaches the second posture, that is, the engagement part 108 is located at the position corresponding to the driving force transmitting portion 180d. The first coupling body 110 no longer abuts against the drum driving component 180. At this moment, the elastic restoring force of the elastic part 114 is released, so that the second coupling body 111 moves toward one side of the drum driving component 180, and the engagement part 108 is engaged with the driving force transmitting portion 180d, so that the coupling 106 may receive the first force applied by the drum driving component 180 and rotate synchronously with the drum driving component 180 along the preset rotation direction A. The coupling 106 drives the movable components to rotate, and then the drum unit 104 rotates, thereby completing the driving action.

When the drum driving component 180 is in the second posture, when the processing cartridge 100 needs to be placed in the image forming device, the processing cartridge 100 is placed on the tray, and then the processing cartridge 100 and the tray are pushed into the image forming device, the front door is closed, and the drum driving component 180 extends along the first direction D1 to engage with the drum unit 104. When the drum driving component 180 extends along the first direction D1, the separation part 107 provided on the coupling 106 is inserted between the movable components (the first movable component 204 and the second movable component 208), and the engagement part 108 corresponds to the position of the driving force transmitting portion 180d, so the coupling 106 may be directly engaged with the drum driving component 180, and then the drum driving component 180 starts to rotate along the preset rotation direction A. The engagement part 108 is engaged with the driving force transmitting portion 180d, so that the coupling 106 may receive the first force applied by the drum driving component 180 and rotate synchronously with the drum driving component 180 along the preset rotation direction A. The coupling 106 drives the movable components to rotate, and then the drum unit 104 rotates, thereby completing the driving action.

The other structures of the processing cartridge 100 of Embodiment 3 are similar to those of Embodiment 1 and will not be described again.

### Embodiment 4

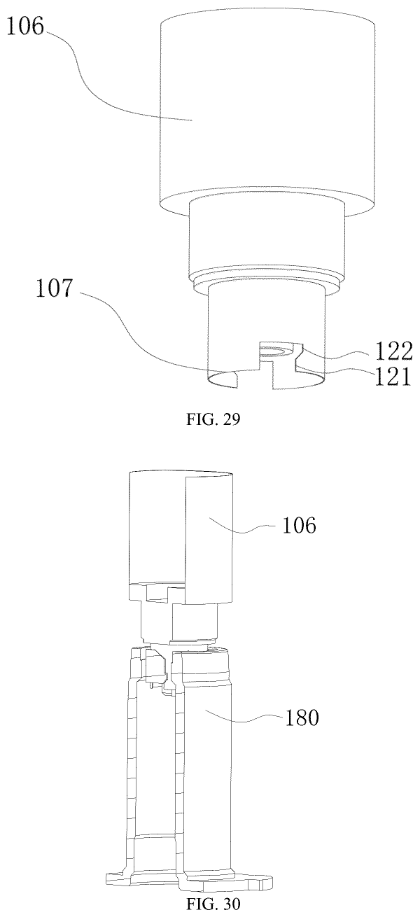

Referring to FIGS. 29 and 30, in the embodiment disclosed herein, the engagement part 108 includes a first groove section 121 and a second groove section 122 which are connected to each other. The width of the second groove section 122 is greater than that of the first groove section 121. The second groove section 122 is closer to the photosensitive drum 105 than the first groove section 121. The width of the second groove section 122 is adapted to the width of the driving force transmitting portion 180d. When the coupling 106 is engaged with the drum driving component 180, the second groove section 122 is engaged with the driving force transmitting portion 180d to receive the driving force applied by the driving force transmitting portion 180d. At this moment, the bottom wall of the second groove section 122 abuts against the surface of the driving force transmitting portion 180d to generate a certain friction force. The direction of the force is opposite to the direction of the first force applied by the driving force transmitting portion 180d, thereby ensuring that the coupling 106 is stably engaged with the drum driving component 180 during printing.

The other structures of the processing cartridge 100 of Embodiment 4 are similar to those of Embodiment 1 and will not be described again.

### Embodiment 5

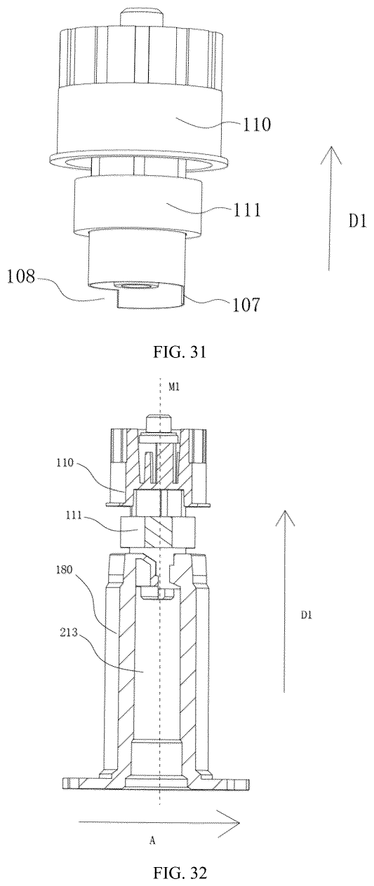

Referring to FIGS. 31 and 32, in the embodiment disclosed herein, unlike Embodiment 2, there is only one engagement part 108 on the coupling 106, the separation part 107 includes an annular protrusion structure protruding from the second end of the coupling 106, and the engagement part 108 is a sheet-like protrusion structure protruding from the end face of the annular protrusion structure.

In the disclosed embodiment, the separation part 107 is an annular protrusion structure, with an outer diameter of approximately 10.9 mm, an inner diameter of 10.5 mm, and a thickness of approximately 0.2 mm. This is conducive to the separation part 107 being inserted between the movable components. The thickness of the annular column is evenly set along the first direction D1, and may also be unevenly set along the first direction D1. The thickness of the annular column is unevenly set along the first direction D1, which is conducive to the separation part 107 and the movable components to generate friction or interference force, so that the processing cartridge 100 and the image forming device are installed more firmly and the engagement is more stable during the printing process.

The length of the separation part 107 along the first direction D1 is greater than or equal to the distance between the upper surface of the driving force transmitting portion 180d and the upper surface of the drum driving component 180, so as to ensure that the driving force transmitting portion 180d is engaged with the engagement part 108 and is used to receive the first force applied by the driving force transmitting portion 180d. Specifically, the length of the separation part 107 along the first direction D1 is approximately 5 mm.

In some embodiments, the separation part 107 has a certain width along the first direction D1, which is conducive to the engagement part 108 receiving the first force applied by the driving force transmitting portion 180d. Specifically, the engagement part 108 is convexly formed on the end surface of the separation part 107, so that the separation part 107 forms a sheet-like protrusion structure in the circumference of the engagement part 108, and the circumferential length of the sheet-like protrusion structure along the preset rotation direction A is greater than or equal to 5 mm. In some embodiments, the height of the sheet-like protrusion structure along the first direction D1 is greater than or equal to the thickness of the driving force transmitting portion 180d along the first direction D1, which is conducive to the stable engagement of the engagement part 108 with the driving force transmitting portion 180d, and is used to stably accept the first force applied by the driving force transmitting portion 180d. Specifically, the height of the sheet-like protrusion structure of the separation part 107 along the first direction D1 is greater than 0.5 mm, so as to ensure that the groove structure of the engagement part 108 is stably engaged with the driving force transmitting portion 180d, and may stably accept the first force applied by the driving force transmitting portion 180d.

The other structures of the processing cartridge 100 of Embodiment 5 are similar to those of Embodiment 3 and will not be described again.

### Embodiment 6

In the embodiment disclosed herein, in order to eliminate abnormal noise when the processing cartridge 100 is matched with the drum driving component 180, the second end of the coupling 106 is provided with a pressing part 123. When the coupling 106 extends into the assembly groove 213, the pressing part 123 abuts against the movable components to push the movable components to move in a direction opposite to the first direction D1.

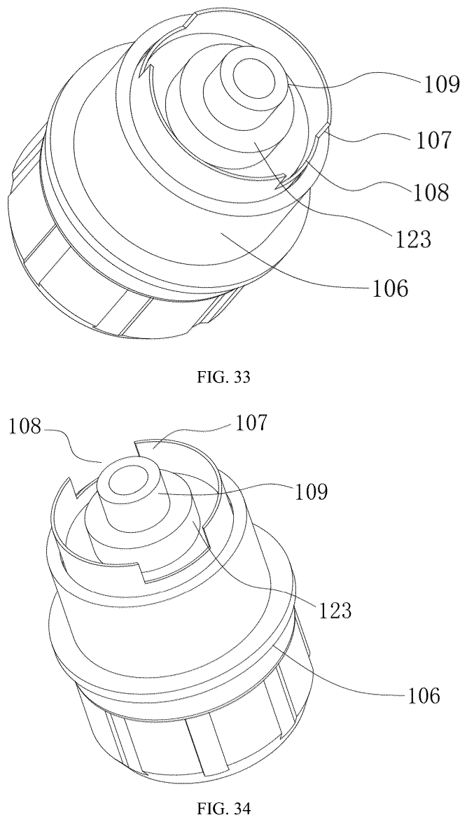

Referring to FIGS. 33 and 34, the pressing part 123 is a truncated cone structure formed at the middle axis position of the second end of the coupling 106. The pressing part 123 is located in the middle area between the positioning matching part 109 and the separation part 107, and there is a gap between the pressing part 123 and the separation part 107. The height of the pressing part 123 is lower than the height of the separation part 107. When the drum driving component 180 moves toward the direction close to the processing cartridge 100, the first movable component 204 and the second movable component 208 abut against the end surface of the pressing part 123, and are pressed by the pressing part 123 during the relative movement. The first movable component 204 and the second movable component 208 move toward the inside of the drum driving component 180, and then the brake transmission member 207 also moves toward the inside of the drum driving component 180 in the direction away from the processing cartridge 100 under the action of the second movable component 208. At this moment, the brake transmission member 207, the first movable component 204 and the second movable component 208 are out of the brake working position, thereby reducing or eliminating the abnormal noise generated when the drum driving component 180 rotates.

The other structures of the processing cartridge 100 of Embodiment 6 are similar to those of Embodiment 3 and will not be described again.

### Embodiment 7

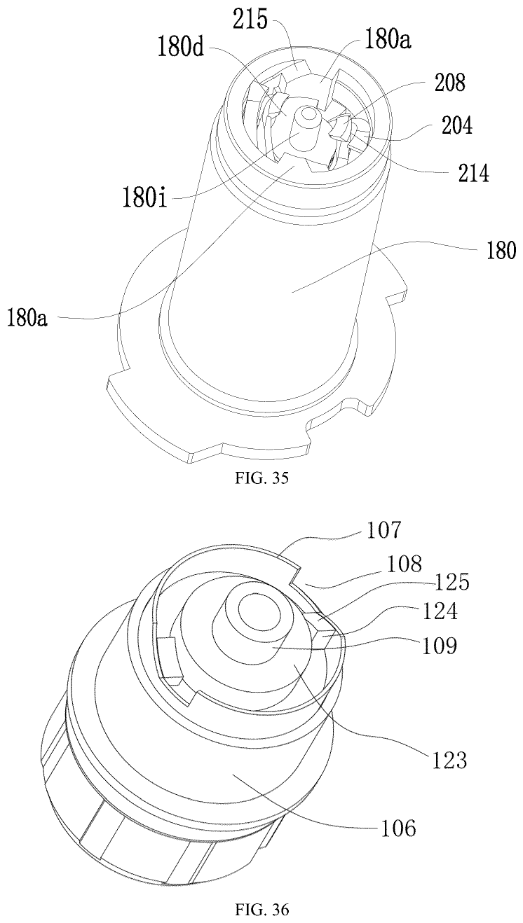

Referring to FIGS. 35 and 36, in the embodiment disclosed herein, a driving force receiving block 124 is convexly provided at the end of the coupling 106. The driving force receiving block 124 is a convex structure. Two driving force receiving blocks 124 are provided, which are respectively arranged on the separation part 107 in a centrally symmetrical manner. Each driving force receiving block 124 is arranged corresponding to the engagement part 108. The end surface of the driving force receiving block 124 facing a direction opposite to the first direction D1 is a driving force receiving surface 125, and the driving force receiving surface 125 is an inclined surface inclined relative to the end surface of the coupling 106. The driving force receiving surface 125 is flush with the surface of the engagement part 108 facing the direction opposite to the first direction D1.

A transfer slope 215 is also provided on the bevel part 180a. When the drum driving component 180 extends along the first direction D1 to engage with the coupling 106, the pressing part 123 pushes the movable components to move in the direction opposite to the first direction D1 to reduce or eliminate the abnormal noise generated when the drum driving component 180 rotates, and the separation part 107 is inserted into a first gap 214 between the first movable component 204 and the second movable component 208, and the transfer slope 215 abuts against the driving force receiving surface 125 of the driving force receiving block 124 to receive the driving force.

The other structures of the processing cartridge 100 of Embodiment 7 are similar to those of Embodiment 6 and will not be described again.

### Embodiment 8

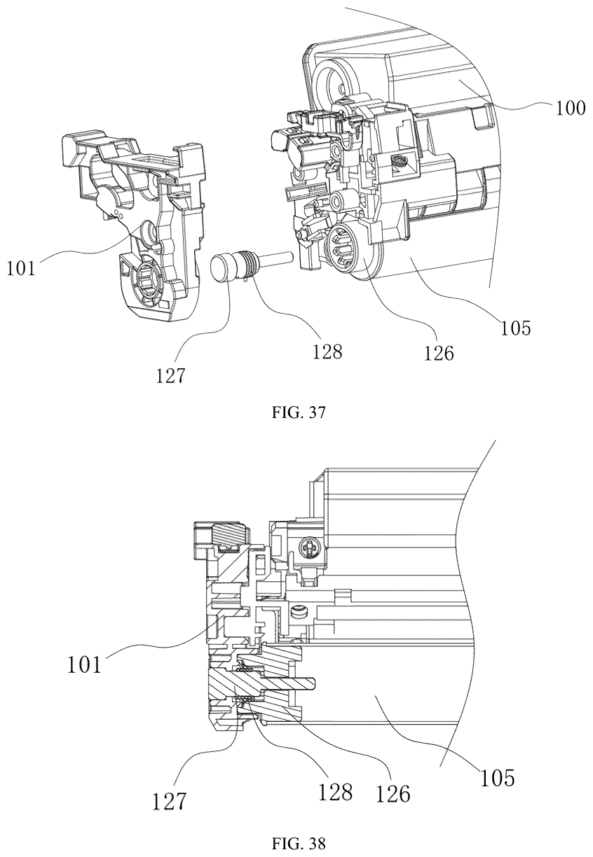

Referring to FIGS. 37 and 38, in the embodiment disclosed herein, a conductive bearing 126 is provided at one end of the photosensitive drum 105 away from the coupling 106, and a force-applying component 128 is also provided in the processing cartridge 100. The force-applying component 128 is used to provide a second force to the coupling 106 and/or the conductive bearing 126. The extension direction of the second force is opposite to the extension direction of the first force. The second force is a braking force, which may ensure that the photosensitive drum 105 does not rotate when the image forming device is just started, and may more easily and quickly engage with the drum driving component and rotate stably.

In some embodiments, the force-applying component 128 is disposed at the conductive end of the processing cartridge 100. Specifically, the force-applying component 128 acts on the conductive bearing 126 to generate a second force on the photosensitive drum 105. The conductive bearing 126 is hollow inside, and a plurality of ribs are disposed on the circumferential inner wall of the conductive bearing 126. The processing cartridge 100 further includes a conductive shaft pin 127, which partially passes through the through hole on the conductive side end cover 101 and is inserted into the conductive bearing 126.

In the disclosed embodiment, the force-applying component 128 is a torsion spring, the coil of which is sleeved on the conductive shaft pin 127 and tightly embraces the conductive shaft pin 127, and is inserted into the conductive bearing 126 together with the conductive shaft pin 127, and the arm of the torsion spring is connected to the rib of the conductive bearing 126. The torsion force of the torsion spring acts on the conductive bearing 126, and then acts on the photosensitive drum 105, thereby generating a second force on the photosensitive drum 105, so that the photosensitive drum 105 rotates stably.

In the disclosed embodiment, a force-applying component 128 for providing a second force is provided on the processing cartridge 100, which may ensure that the photosensitive drum 105 does not rotate when the image forming device is just started, and may more easily and quickly engage with the drum driving component 180 and rotate stably.

The other structures of the processing cartridge 100 of Embodiment 8 are similar to those of Embodiment 6 and will not be described again.

### Embodiment 9

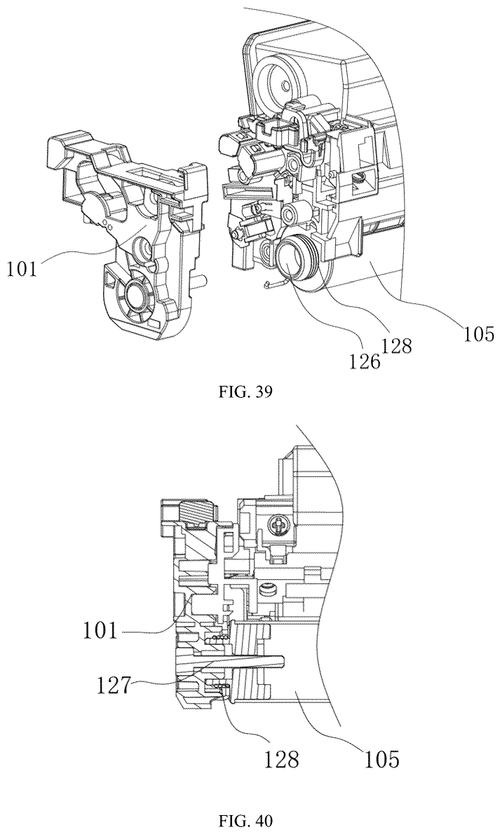

Referring to FIGS. 39 and 40, in the embodiment disclosed herein, the force-applying component 128 is a torsion spring, the coil of which is sleeved on the outer circumferential surface of the conductive bearing 126 and holds the conductive bearing 126 tightly. The arm of the torsion spring abuts against the conductive side end cover 101. The torsion spring is interference-fitted on the conductive bearing 126, and the arm of the torsion spring is snap-fitted and fixed on the conductive side end cover 101. When the photosensitive drum 105 rotates (the conductive bearing 126 rotates synchronously), the torsion spring does not rotate therewith, and the torsion force of the torsion spring acts on the conductive bearing 126, and then acts on the photosensitive drum 105, thereby generating a second force on the photosensitive drum 105, so that the photosensitive drum 105 rotates stably.

The other structures of the processing cartridge 100 of Embodiment 9 are similar to those of Embodiment 8 and will not be described again.

### Embodiment 10

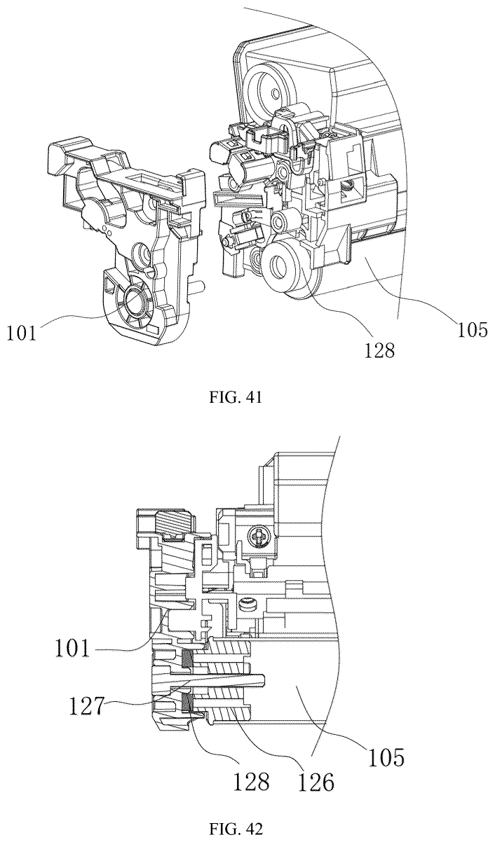

Referring to FIGS. 41 and 42, in the embodiment disclosed herein, the force-applying component 128 is an annular component, and is fixedly disposed on the end surface of the conductive bearing 126 facing the conductive side end cover 101. The force-applying component 128 may be a rubber ring or rubber band that may be squeezed and deformed. The force-applying component 128 is located between the conductive bearing 126 and the conductive side end cover 101. The force-applying component 128 is squeezed and deformed, thereby generating a friction force between the conductive side end cover 101 and the conductive bearing 126. The friction force provides a second force acting on the photosensitive drum 105, so that the photosensitive drum 105 rotates stably.

The other structures of the processing cartridge 100 of Embodiment 10 are similar to those of Embodiment 8 and will not be described again.

### Embodiment 11

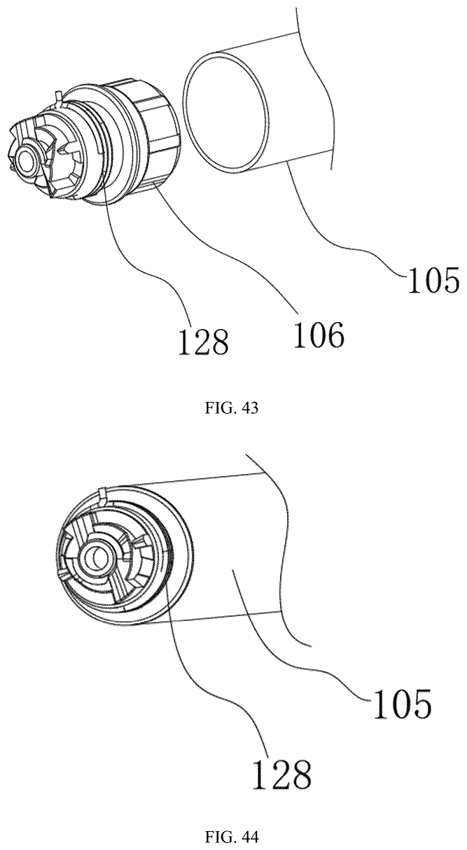

Referring to FIGS. 43 and 44, in the embodiment disclosed herein, the force-applying component 128 is a torsion spring, the coil portion of which is sleeved on the outer circumferential surface of the coupling 106 and holds the coupling 106. The torsion spring is interference-mounted on the coupling 106, and the arm portion of the torsion spring is snap-fitted and fixed on the drive side end cover 102. When the coupling 106 drives the photosensitive drum 105 to rotate, the torsion spring does not rotate therewith, and the torsion force of the torsion spring acts on the coupling 106, and then acts on the photosensitive drum 105, thereby generating a second force on the photosensitive drum 105, allowing the photosensitive drum 105 to rotate stably.

The other structures of the processing cartridge 100 of Embodiment 11 are similar to those of Embodiment 8 and will not be described again.

### Embodiment 12

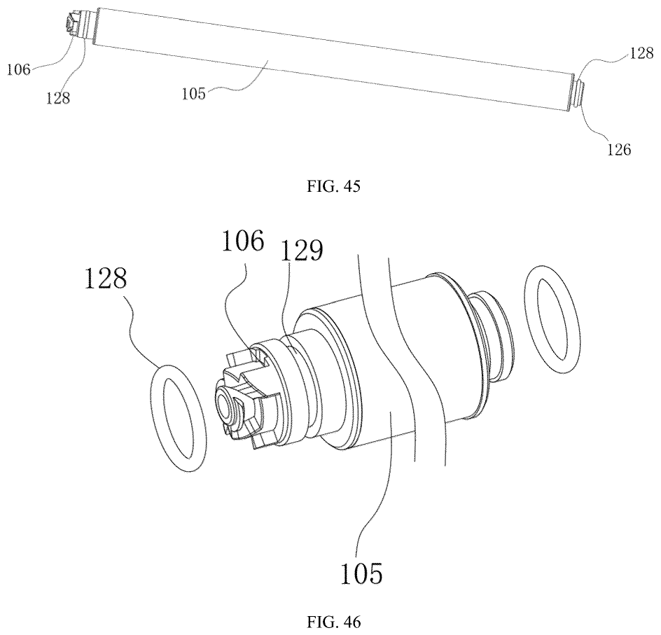

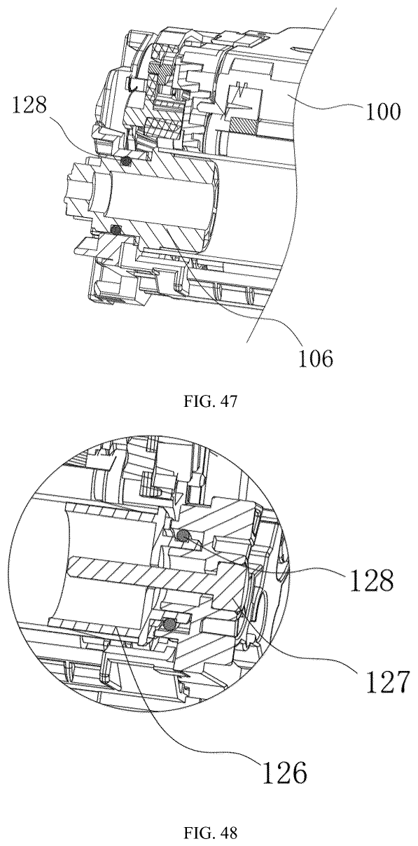

Referring to FIGS. 45 to 48, in the embodiment disclosed herein, the force-applying component 128 is a rubber ring or a rubber band, and an annular groove 129 is provided on the circumferential surface of the coupling 106. The force-applying component 128 is placed in the annular groove 129. When the coupling 106 is supported in the through hole of the drive side end cover 102, the part of the force-applying component 128 protruding from the circumferential surface of the coupling 106 contacts and is squeezed by the drive side end cover 102, thereby generating a friction force between the drive side end cover 102 and the coupling 106. The friction force provides a second force acting on the photosensitive drum 105, so that the photosensitive drum 105 rotates stably.

Furthermore, a force-applying component 128 may also be arranged at the conductive end. Specifically, an annular groove 129 is provided on the circumferential surface of the conductive bearing 126 of the conductive end of the photosensitive drum 105. The force-applying component 128 is a rubber ring or a rubber band, which is sleeved in the annular groove 129 of the conductive bearing 126 and contacts and is squeezed by the conductive side end cover 101. The friction force between the two provides a second force acting on the photosensitive drum 105.

Compared with the existing technologies, the coupling in the processing cartridge provided by the present disclosure has a separation part and an engagement part, and the drum driving component of the image forming device has a driving force transmitting portion. When the drum driving component moves back and forth along the first direction, the structure of the coupling will not hinder the movement of the drum driving component. This may not only ensure the normal and stable printing process, but also facilitate the separation of the coupling and the drum driving component, thereby avoiding a situation where the coupling and the drum driving component cannot be separated smoothly, and ensuring that a user can successfully complete the disassembly action.

The foregoing describes in detail the structures, features and effects of the present disclosure based on the embodiments shown in the drawings. The above are only some embodiments of the present disclosure, but the present disclosure is not limited to the scope of embodiments shown in the drawings. Any changes made according to the concept of the present disclosure, or modified into equivalent embodiments with equivalent changes, which still do not exceed the spirit covered by the description and the drawings, should be within the protection scope of the present disclosure.

What is claimed is:

1. A coupling of a processing cartridge, wherein the process cartridge is detachably mounted in a main assembly of an electronic imaging device, the main assembly includes a drum drive transmission unit, the drum drive transmission unit includes a drum driving component and a braking force applying assembly, the drum driving component is provided with a driving force transmitting portion, and the coupling is capable of receiving a first force applied by the driving force transmitting portion to rotate; and
the coupling further includes an engagement part, which is a groove structure, wherein the groove structure of the engagement part is engaged with the driving force transmitting portion to receive the first force applied by the driving force transmitting portion to rotate.

2. The coupling of the processing cartridge according to claim 1, wherein the drum driving component further includes a bevel part and a positioning part, and the driving force transmitting portion is connected to the bevel part and is located between the positioning part and the bevel part.

3. The coupling of the processing cartridge according to claim 2, wherein:
an assembly groove is provided in the drum driving component, and the braking force applying assembly includes a first movable component;
the driving force transmitting portion is formed in the assembly groove, and the first movable component is disposed in the assembly groove; and
the positioning part is formed in the assembly groove and is disposed at a central axis position of the drum driving component, and the driving force transmitting portion is symmetrically arranged on opposite sides of a center line of the positioning part.

4. The coupling of the processing cartridge according to claim 3, wherein the first movable component is movable in an axial direction relative to the drum driving component.

5. The coupling of the processing cartridge according to claim 4, wherein the drum driving component is capable of moving in the axial direction and extending out by a preset distance.

6. The coupling of the processing cartridge according to claim 5, wherein the drum driving component is capable of moving in the axial direction to achieve an extension or retraction action.

7. The coupling of the processing cartridge according to claim 6, wherein the braking force applying assembly further includes a second movable component, the first movable component and the second movable component are engaged with each other, and the second movable component is located on an inner side of the first movable component, which means that the second movable component is closer to the positioning part of the drum driving component than the first movable component.

8. The coupling of the processing cartridge according to claim 2, wherein the coupling further includes a positioning matching part, and when the processing cartridge is installed on the main assembly, the positioning part of the drum driving component is capable of being inserted into the positioning matching part for engagement.

9. The coupling of the processing cartridge according to claim 8, wherein the positioning matching part is provided with a conical chamfer.

10. The coupling of the processing cartridge according to claim 1, wherein:
the coupling further includes a separation part, the braking force applying assembly includes a movable component, and the movable component is capable of moving along an axial direction relative to the drum driving component; and
when the processing cartridge is installed on the main assembly, the separation part is inserted into the movable component.

11. The coupling of the processing cartridge according to claim 10, wherein:
the movable component includes a first movable component and a second movable component, the first movable component and the second movable component are engaged with each other; and
the separation part is inserted between the first movable component and the second movable component.

12. The coupling of the processing cartridge according to claim 10, wherein the separation part is an annular protrusion structure, and the engagement part is formed at a lower end of the separation part.

13. The coupling of the processing cartridge according to claim 1, wherein a width of the groove structure of the engagement part is greater than or equal to a width of the driving force transmitting portion.

14. The coupling of the processing cartridge according to claim 13, wherein:
the groove structure of the engagement part includes a first groove section and a second groove section, a width of the second groove section is greater than a width of the first groove section; and
the width of the first groove section is adapted to the width of the driving force transmitting portion.

15. The coupling of the processing cartridge according to claim 14, wherein there are two engaging parts, and the two engaging parts are symmetrically arranged on the coupling.

16. The coupling of the processing cartridge according to claim 1, wherein:
a bottom wall is provided on the engagement part; and
when the engagement part is engaged with the driving force transmitting portion, the bottom wall is engaged with at least a portion of the driving force transmitting portion to generate a force in an opposite direction to the first force applied by the driving force transmitting portion.

17. The coupling of the processing cartridge according to claim 16, wherein, when the bottom wall is engaged with the driving force transmitting portion, the bottom wall abuts against a surface of the driving force transmitting portion to generate the force in the opposite direction to the first force.

18. A processing cartridge, comprising a coupling, wherein the process cartridge is detachably mounted in a main assembly of an electronic imaging device, the main assembly includes a drum drive transmission unit, the drum drive transmission unit includes a drum driving component and a braking force applying assembly, the drum driving component is provided with a driving force transmitting portion, and the coupling is capable of receiving a first force applied by the driving force transmitting portion to rotate; and
the coupling further includes an engagement part, which is a groove structure, wherein the groove structure of the engagement part is engaged with the driving force transmitting portion to receive the first force applied by the driving force transmitting portion to rotate.
